(19) United States
(12) Patent Application Publication
(10) Pub. No.: US 2006/0107977 A1
(43) Pub. Date: May 25, 2006

(54) Method of continuously treating batches of pre-washed lettuces prior to packaging them as well as an installation designed to implement this method

(76) Inventor: Laurent Savary, Angoville Sur Ay (FR)

Correspondence Address: BAKER & DANIELS LLP;111 E. WAYNE STREET, SUITE 800, FORT WAYNE, IN, 46802, US

(21) Appl. No.: 11/262,702

(22) Filed: Oct. 31, 2005

(30) Foreign Application Priority Data
Nov. 4, 2004 (FR) 04 52 523

(51) Int. Cl. B08B 3/00

(52) U.S. Cl. 134/134

(57) ABSTRACT

Installation characterised in that it comprises a central rotating column (1) bearing a set of tilting arms (2) uniformly distributed around its periphery and extending radially out from it, each equipped, at its free end, with a support (5) which pivots about an axis (4) essentially perpendicular to its longitudinal axis and bearing a perforated basket (3) designed to hold a batch of lettuces to be treated, this perforated basket (3) being mounted so as to rotate about its axis (xx′), and a set of treatment stations (I to X) uniformly distributed in a circular arrangement around the central rotating column (1), in alignment with the perforated baskets (3), and each being designed to co-operate with one of these respective baskets (3), which central rotating column (1) is displaced in a step by step movement to enable each of the perforated baskets (3) to be continuously transferred from one treatment station to another.

The present invention relates to a method of continuously processing batches of pre-washed lettuces prior to packaging them, in particular in bags intended to be displayed on the fresh vegetable counter of retail outlets.

It should be pointed out that the term [symbol] lettuces [symbol] used in the context of this description should be interpreted in a very general sense and is used to refer to all types of salad leaves (endive, curly lettuce, lettuce, lamb's lettuce . . . ) but also to other chopped or grated fresh vegetables, in particular celery, carrots, cabbage . . .

The sole method of conserving fresh fruits or vegetables has for a long time been canning, the disadvantage of which is that it alters the taste of the foods.

More recently, specialists in the food and agricultural industry have developed deep-freezing methods, which have the advantage of preserving both the appearance and the organoleptic qualities of the foodstuffs.

However, these methods do not lend themselves to all foods and there are many, salad vegetables in particular, which can not be deep-frozen.

The specialists then endeavoured to find ways of presenting products that were not suitable for deep-freezing in a ready-to-use format with a longer shelf life.

So it was that so-called [symbol] fourth range [symbol] products made their appearance on the market and immediately found favour with consumers.

Such products are salad vegetables (or other fresh or chopped vegetables) packaged in air or under a modified atmosphere in bags made from thermoplastic films that are permeable to gases to a greater or lesser degree.

These bags are stored at temperatures of +2 to +4° C.

However, the shelf life of products packaged in this manner, which are living products, is limited by the inevitable development of micro-organisms and also by the appearance of brown marks which appear on a level with the cuts and tend to alter their appearance.

These phenomena are attributable to the fact that the effect of oxidation causes vegetable cells to secrete polyphenols and polyphenol oxidase, which is what causes the brown colour observed.

Consequently, and in spite of using products that are as fresh as possible and observing optimum hygiene conditions with respect to peeling, cutting and washing as well as packaging, the shelf life of fresh foods packaged in bags can not be more than a few days.

As a means of increasing this shelf life, it has already been proposed that, having been washed beforehand, the products to be packaged in bags should be treated in baths containing disinfectants and anti-oxidants.

This being the case, the active agent which is most frequently used is chlorine, the efficacy of which as both a disinfectant and an anti-browning agent is well known to specialists but which nevertheless has a negative image amongst consumers.

Document FR 2852492 A also proposed subjecting lettuces to be packaged in bags to a thermal shock by immersing them in water at a temperature ranging between 45 and 60° C.; in effect, it had been noted that such a thermal shock had the effect of enhancing the action of the chlorine, which meant that lesser quantities of the latter could be used or even disinfectants and antioxidants containing no chlorine at all.

This phenomenon is due to the fact that the thermal shock enables the metabolism of the vegetable cells to be modified by pushing them to secrete proteins which act as a ((decoy)) so as to block the secretion of polyphenols and polyphenol oxidase which cause the phenomenon of browning.

In this context, it would be desirable to have a method and an installation that would allow batches of lettuces to be fed through different baths once they have been pre-washed and before they are packaged in readiness for storage and to do so on a continuous or at least kinematically continuous basis.

At this point in time, specialists do not have the means of achieving this result.

The objective of the present invention is to bridge this gap by proposing a method of treating batches of lettuces (or other chopped or grated fresh vegetables), which have been pre-washed prior to their packaging, in particular in bags, characterised by the following series of steps:
each batch of lettuces is introduced into an essentially cylindrical or conical perforated basket mounted so as to rotate about its axis,
the perforated basket thus filled is immersed successively in a series of washing or treatment baths whilst rotating it about its axis and
having removed the perforated basket from the last treatment or washing bath, the lettuces contained in it are dried by continuing to rotate it before removing them in readiness for packaging.

As a general rule, the perforated basket proposed by the invention is similar to that fitted in washing machines and may be equipped to open from the front or side. Its rotation speed may vary, depending on the baths.

The series of washing or treatment baths may include a thermal shock bath containing water, which may or may not be activated, at a temperature ranging between 40 and 60° C. and/or a disinfectant bath made up of an aqueous solution containing a disinfectant, preferably at a temperature of approximately 15° C. and/or a rinsing and cooling bath containing iced water at approximately 2 to 4° C.

Naturally, the washing or treatment baths for the lettuces may correspond to those described in the earlier document FR 2852492 A or other baths.

To obtain a sufficient efficacy, it is necessary to immerse the perforated basked filled with lettuces in each of these washing or treatment baths for a period of 20 to 40 seconds, preferably in the order of 30 seconds, as a rule.

For the purpose of the invention, it is also necessary to subject the lettuces to a drainage step before transferring the perforated basket from one washing or treatment bath to another, the aim being to avoid transferring too much treatment liquid from one bath to another.

This drainage step is operated by raising the perforated basket above the washing or treatment bath and continuing to rotate it.

In accordance with another characterising feature of the invention, before the perforated basket filled with lettuces is immersed in the successive washing or treatment baths, it is oriented so that its axis of rotation is essentially horizontal.

This orientation has proved to be preferable with a view to obtaining optimum efficiency.

In order to improve this efficiency, air can also be injected into the perforated basket and can be so as a means of promoting contact between the lettuces and the washing or treatment liquid.

Furthermore and in accordance of another particularly advantageous feature of the invention, the final step of drying the lettuces is operated over two periods, namely, on the one hand, a first period during which the perforated basket is oriented so that its axis of rotation is essentially vertical, and, on the other hand, a second period during which the perforated basket is oriented so that its axis of rotation is essentially horizontal.

The first period helps to promote the onset of drying by distributing the lettuces at the periphery of the perforated basket, which would not be possible if the drying process were operated about a horizontal axis from the start.

Such a regular distribution of the lettuces is necessary in practice to prevent them from being damaged by impact or crushing.

The invention furthermore and essentially relates to an installation designed to operate the above-mentioned process on a continuous basis.

This installation is characterised by the fact that it has, on the one hand, a central rotating column, displaced in a step by step movement, bearing a set of tilting arms uniformly distributed around its periphery and extending radially out from it, each of which, at its outer end, is fitted with an essentially cylindrical or conical perforated basket for holding a batch of lettuces to be treated, and, on the other hand, a set of treatment stations uniformly distributed around the central rotating column in alignment with the perforated baskets and each being designed to co-operate with these respective baskets.

More specifically, for the purpose of the invention, the perforated baskets, which may have a front opening or a side opening for introducing the lettuces, are each secured on a support mounted so as to pivot at the outer end of the associated tilting arm and to do so about an axis that is substantially perpendicular to the longitudinal axis of this arm.

This configuration enables the baskets to be displaced between different positions during the course of the different steps of the process of treating the lettuces.

In particular, once the associated support has been pivoted, each of the perforated baskets may be displaced between a filling position, in which it is turned upwards with its axis vertical, an immersion position in which its axis is in a horizontal position and a draining and drying position in which it is turned downwards with its axis vertical.

Each of these baskets is also mounted to be rotatable about its axis so that it can be driven at a variable speed by a motor and preferably can be so via a pulley transmission.

As proposed by the invention, the number of tilting arms and perforated baskets is naturally equal to the number of treatment stations so that with each displacement step of the central rotating column, each of the baskets and hence each batch of lettuces is transferred from one treatment station to the subsequent treatment station.

For the purpose of the invention, these treatment stations include a station for filling the baskets, a series of immersion stations each comprising a tank containing a washing or treatment bath, at least one drying station and a draining and cleaning station, as a rule.

The tilting action of the arms enables the perforated baskets to be lifted out of the immersion tanks.

From the draining and cleaning station, each of the baskets is transferred to the filling station, enabling the installation to effect a continuous treatment of different batches of lettuces.

As proposed by the invention, the immersion tanks are equipped with means for circulating the washing or treatment bath which they contain as well as filters.

It should be pointed out that although the lettuces are pre-washed, there are often still small light particles and possibly grains of sand in them which can drop through the perforations of the baskets and into the immersion tanks.

The light products float and are skimmed off.

The heavy products drop to the bottom of the tanks and are removed by filtering.

By virtue of another characterising feature of the invention, during treatment of the batches of lettuces, each perforated basket remains for approximately 15 seconds in alignment with each treatment station, this period corresponding to the minimum time needed to load a perforated basket with a batch of lettuces or drain it.

In view of the fact that it is necessary for the lettuces to remain in each bath for approximately 30 seconds in order for the treatment to be effective, it is necessary to provide two stopping stations and hence two treatment stations in each immersion tank.

Naturally, the geometry of these tanks may be adapted to satisfy this requirement.

The characteristics of the method as well as the device proposed by the invention-will be described in more detail below with reference to the appended drawings, although these are not intended to be restrictive in any way, of which:

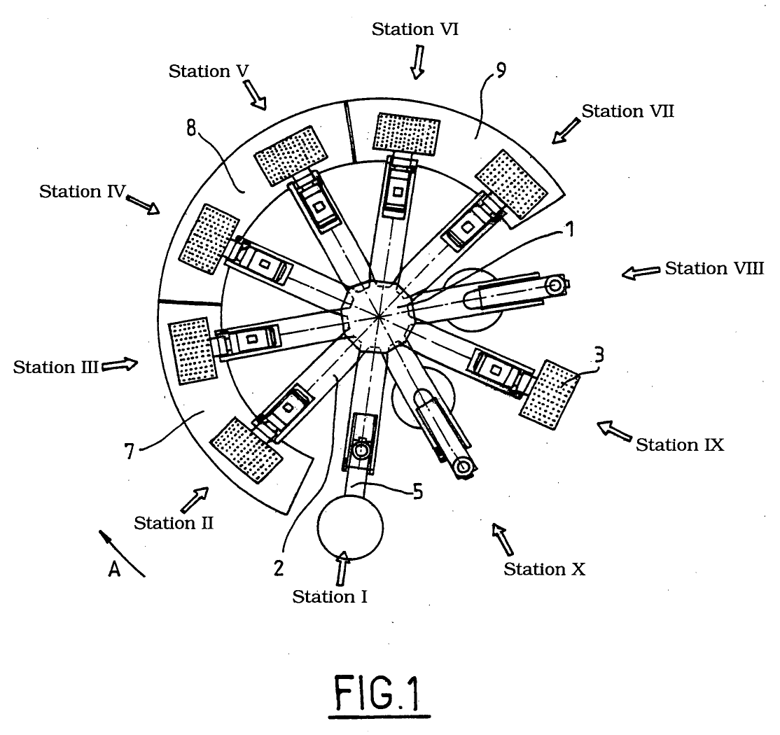

FIG. 1 is a plan view of the device,

FIG. 2 shows a tilting arm equipped with a perforated basket in the filling position,

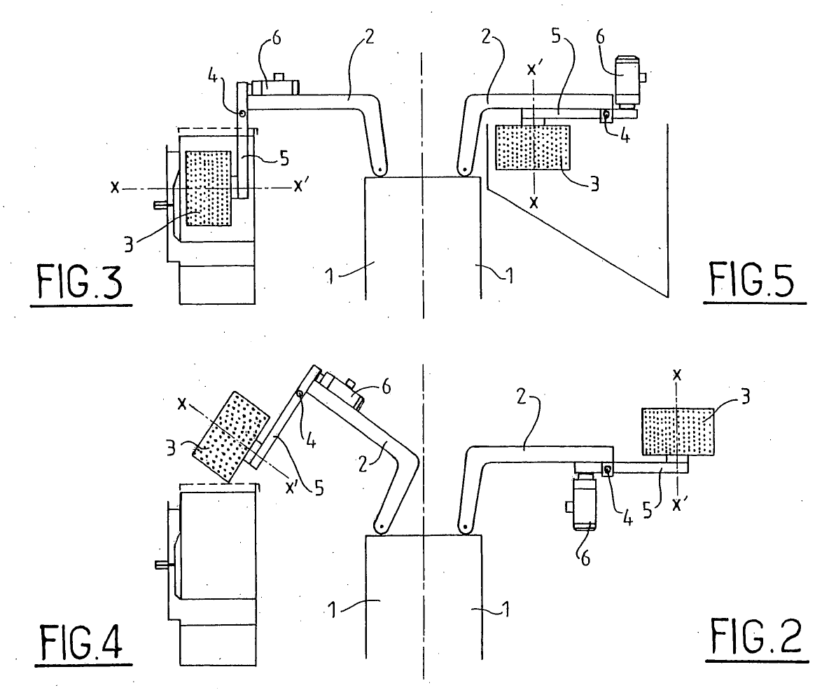

FIG. 3 shows a tilting arm equipped with a perforated basket immersed in an immersion tank,

FIG. 4 shows a tilting arm equipped with a perforated basked raised above an immersion tank,

FIG. 5 shows a tilting arm equipped with a perforated basket in the drying and draining position.

As illustrated in FIG. 1, the installation essentially comprises, on the one hand, a central rotating column 1 displaced in a step by step movement, bearing ten tilting arms 2 uniformly distributed around its periphery and extending out radially from it, and each equipped with a cylindrical perforated basket 3 designed to hold a batch of lettuces to be treated, and, on the other hand, ten treatment stations denoted by reference numbers I to X uniformly distributed in a circular arrangement around the central rotating column 1 in alignment with the perforated baskets 3.

As will become apparent in more detail later on in this description, a rotation of the central rotating column 1 by one step in the clockwise direction A enables each of the respective baskets 3 to be continuously transferred from one treatment station to the next; during this movement, each of the treatment stations I to X co-operates with a respective basket 3.

More specifically and as illustrated in FIGS. 1 to 5, each of the tilting arms 2 has an angled portion and is designed with the shape of a fork at its outer end. Mounted on a level with this fork and bearing a perforated basket 3 is a support 5 which rotates about an axis 4 perpendicular to the longitudinal axis of the tilting arm 2.

Each of the perforated baskets 3 is equipped with a front opening, not illustrated in the drawings, and is driven in rotation about its axis at a variable speed by means of a motor 6, and is so via a pulley transmission, not illustrated in the drawings.

On the basis of this configuration, each of the perforated baskets 3 can be displaced between:
a filling position illustrated in FIG. 2 in which its axis axe xx′ is vertically oriented and the front opening is upwardly directed,
a washing or treatment position illustrated in FIG. 3 in which its axis xx′ is horizontally oriented,
a transfer position illustrated in FIG. 4 in which its axis xx′ is obliquely oriented and the angled arm 2 is tilted relative to the central rotating column 1, and
a draining or drying position illustrated in FIG. 5 in which its axis xx′ is vertically oriented and the front opening is downwardly directed.

As illustrated in FIG. 1:
Station I corresponds to a filling station, on a level with which a batch of pre-washed lettuces is introduced into a perforated drum 3.
Stations II and III are immersion stations with an immersion tank 7 filled with a thermal shock bath comprising activated water at a temperature ranging between 45 and 60° C.
Stations IV and V are immersion stations with an immersion tank 8 filled with a disinfectant bath comprising an aqueous solution containing a disinfectant at a temperature of approximately 15° C.
Stations VI and VII are immersion stations with an immersion tank 9 filled with a rinsing and cooling bath containing iced water at 2 to 4° C.
Stations VIII and IX are drying stations.
Station X is a station for draining and cleaning the perforated baskets 3.

Each of the immersion tanks 7, 8, 9 is disposed as an extension of the other and its shape is that of a circle segment, each of identical dimensions.

The time needed to fill the perforated baskets is 15 seconds and the duration of the immersion of the batches of lettuces in the different treatment baths must be in the order of 30 seconds. It is therefore necessary to provide two treatment stations per immersion tank 7, 8 and 9.

This installation operates in the following manner:

On a level with station I, the perforated basket is placed in the filling position illustrated in FIG. 2 and is filled with a batch of pre-washed lettuces (as a general rule weighing in the order of 4 kg in the case of endives or curly lettuces, 3 kg in the case of lettuces 2 kg in the case of lamb's lettuce).

The perforated basket 3 is then placed in the washing and treatment position illustrated in FIG. 3 and is immersed in the immersion tank 7 on a level with station II followed by station III so that the batch of lettuces is subjected to a thermal shock.

On leaving station III, the perforated basket 3 is placed in the transfer position illustrated in 4 by tilting the angled arm 2 to enable the lettuces to drain and avoid transferring too much liquid from tank 7 to tank 8, and is then placed back in the washing and treatment position illustrated in FIG. 2 before being immersed in tank 8 on a level with station IV and then station V so that the batch of lettuces is disinfected.

It should be pointed out that the batch of lettuces is also pre-chilled in tank 8 given that the temperature of the water contained in this bath is in the order of 15° C.

On leaving tank 8, the perforated basket 3 is again placed in the transfer position illustrated in FIG. 4 to enable the lettuces to drain and is then placed back in the washing and treatment position illustrated in FIG. 3 before being immersed in tank 9 so that the lettuces are rinsed and chilled by the iced water contained in this bath.

It should be noted that during the course of its treatment on a level with stations II to VII, the perforated basket 3 is constantly displaced in a rotating motion about its axis at a speed which may vary depending on the tanks 7, 8 or 9.

On leaving immersion tank 9, the perforated basket 3 is placed in the drying and draining position illustrated in FIG. 5 and transferred to station VIII whilst continuing its rotation in order to start the process of drying the lettuces by distributing them around the periphery of the basket.

On leaving station IX, the perforated basket 3 is placed once more in the drying and draining position illustrated in 5 and transferred to station X for its final drying.

This basket 3 now merely has to be returned to the filling position illustrated in FIG. 2 and filled with another batch of lettuces on a level with station I so that the cycle can continue.

1) Installation for continuously treating batches or lettuces (or other grated or chopped fresh vegetables) which have been pre-washed prior to packaging, in particular in bags, characterised in that it comprises:
a central rotating column (1) bearing a set of tilting arms (2) distributed uniformly around its periphery and extending radially out from it, each being fitted, at its free end, with a support (5) which can be pivoted about an axis (4) essentially perpendicular to its longitudinal axis and bearing an essentially cylindrical or conical perforated basket (3) with a front or side opening designed to hold a batch of lettuces to be treated, this perforated basket (3) being mounted so as to rotate about its axis (xx′), and
a set of treatment stations (I to X) uniformly distributed in a circular arrangement around the central rotating column (1), in alignment with the perforated baskets (3) and each designed to co-operate with one of these respective baskets (3),
the central rotating column (1) being displaced in a step by step movement to enable each of the perforated baskets (3) to be transferred continuously from one treatment station to another.

2) Installation as claimed in claim 1, characterised in that the treatment stations include a station for filling the baskets (I), a series of immersion stations (II to VII) each having an immersion tank (7, 8, 9) containing a washing or treatment bath, at least one drying station (VIII, IX) and a draining and cleaning station (X).

3) Installation as claimed in claim 2, characterised in that the series of washing or treatment baths includes a thermal shock bath comprising water, which may or may not be activated, at a temperature ranging between 40 and 60° C. and/or a disinfectant bath comprising an aqueous solution containing a disinfectant, preferably at a temperature of approximately 15° C. and/or a rinsing and cooling bath containing iced water at approximately 2 to 4° C.

4) Method of continuously treating batches of lettuces (or other grated or chopped fresh vegetables) which are pre-washed prior to packaging, in particular in bags, in an installation as claimed in claim 1, characterised by the following succession of steps:
each batch of lettuces is introduced into one of the perforated baskets (3) of the installation,
the perforated basket (3) thus filled is successively immersed in the washing or treatment baths whilst rotating it about its axis (xx′) and,
having lifted the perforated basket (3) out of the last washing or treatment bath, the lettuces contained in it are dried by continuing to rotate it before removing them in readiness for packaging them.

5) Method as claimed in claim 4, characterised in that the perforated basket (3) filled with lettuces is immersed in each of the washing or treatment baths for 20 to 40 seconds.

6) Method as claimed in claim 1, characterised in that before transferring the perforated basket (3) filled with lettuces from one washing or treatment bath to another, the lettuces are subjected to a drying stage.

7) Method as claimed in, claim 1 characterised in that before immersing the perforated basket (3) filled with lettuces into the successive washing or treatment baths, it is oriented so that its axis of rotation (xx′) is essentially horizontal.

8) Method as claimed in claim 1, characterised in that the drying step is operated over two periods, namely, on the one hand, a first period during which the perforated basket (3) is oriented so that its axis of rotation (xx′) is essentially vertical in order to distribute the lettuces at its periphery and, on the other hand, a second period during which the perforated basket (3) is oriented so that its axis of rotation (xx′) is essentially horizontal.

9) Method as claimed in claim 1, characterised in that each perforated basket (3) remains in alignment with each treatment station (I to X) for approximately 15 seconds.
